(19) United States
(12) Patent Application Publication
(10) Pub. No.: US 2018/0209897 A1
(43) Pub. Date: Jul. 26, 2018

(54) DETECTING DEVICE, OPTICAL DETECTING APPARATUS, AND OPTICAL DETECTING METHOD

(71) Applicant: SONY CORPORATION, Tokyo (JP)

(72) Inventor: NAOKI MORIMOTO, TOKYO (JP)

(21) Appl. No.: 15/745,004

(22) PCT Filed: May 25, 2016
(86) PCT No.: PCT/JP2016/065392

§ 371 Date: Jan. 15, 2018

(30) Foreign Application Priority Data
Jul. 31, 2015 (JP) 2015-152861

(51) Int. Cl. G01N 21/15

(52) U.S. Cl. CPC G01N 21/15; G01N 2021/151; G01N 2021/152

(57) ABSTRACT

In optical detection, a technology of efficiently removing dust, dirt and the like adhering to an optical system member is provided. Provided is a detecting device used for an optical detecting apparatus including a main body provided with a sample holding unit which holds a sample, and a light transmitting portion facing at least a part of the sample holding unit and located on an optical path in the optical detecting apparatus at the time of installation on the optical detecting apparatus, and a cleaning unit arranged at a position opposed to a member on the optical path in the optical detecting apparatus.

### TECHNICAL FIELD

The present technology relates to a detecting device. More specifically, this relates to a detecting device, and an optical detecting apparatus and an optical detecting method for detecting using the detecting device.

### BACKGROUND ART

In recent years, importance of analysis/measurement on site where the analysis/measurement is required or in the vicinity of the site (hereinafter, referred to as “POC analysis and the like”) such as analysis for bedside diagnosis to perform measurement necessary for medical diagnosis in the vicinity of a patient (point of care (POC) analysis), analysis of harmful substances in rivers and waste materials on site such as the rivers and waste sites, and contamination test on each site of food preparation, harvest, and import attracts attention.

In this POC analysis and the like, a device for introducing a subject such as an analysis chip and a cartridge is used (for example, refer to Patent Documents 1 and 2). By installing this device on a predetermined site of an apparatus, detection/analysis is performed.

Various methods such as optical detection and electrical detection are used for the detection/analysis described above; there is a problem that an optical characteristic is deteriorated due to dust, dirt and the like adhering to an optical system member, thereby increasing possibility of erroneous detection especially in a case where optical detection is performed.

As a technology for removing dust, dirt and the like adhering to the optical system member, for example, there is a method of actively vibrating the optical system member with ultrasonic waves and the like to remove dust and dirt. However, in this method, various problems such as an increase in size of the apparatus and an increase in apparatus cost in order to form a vibration generating mechanism, and further a breakdown of the vibration generating mechanism and an increase in maintenance cost occur.

In addition, Patent Document 3 discloses a technology of removing dust on an upper surface of a measuring chip when positioning the measuring chip by providing a brush for removing dust on the upper surface of the measuring chip in a positioning mechanism of the measuring chip. However, although rubber on the upper surface of the measuring chip may be removed with this technology, dust, dirt and the like adhering to an optical system member on an apparatus side cannot be removed.

### CITATION LIST

### Patent Document

### Patent Document 1: Japanese Patent Application Laid-Open No. 2004-028589

### Patent Document 2: Japanese Unexamined Patent Publication No. 2001-527720

### Patent Document 3: Japanese Patent Application Laid-Open No. 2004-053275

### SUMMARY OF THE INVENTION

### Problems to be Solved by the Invention

As described above, there is a problem that, in a case where the optical detection is performed, the optical characteristic is deteriorated due to dust, dirt and the like adhering to the optical system member, and the possibility of erroneous detection increases. Especially, in the apparatus in which the device for introducing the subject such as the analysis chip and the cartridge is used, the possibility of contamination of dust and the like increases by insertion and removal of this device.

Therefore, a main object of the present technology is to provide a technology of efficiently removing dust, dirt and the like adhering to the optical system member in the optical detection.

### Solutions to Problems

As a result of serious study in order to solve the above-describes object, the inventor of the present invention succeeded in efficiently removing dust, dirt and the like adhering to the optical system member by focusing on a structure of the device, thereby completing the present technology.

That is, the present technology first provides a detecting device used for an optical detecting apparatus including

a main body provided with a sample holding unit which holds a sample, and a light transmitting portion facing at least a part of the sample holding unit and located on an optical path in the optical detecting apparatus at the time of installation on the optical detecting apparatus, and

a cleaning unit arranged at a position opposed to a member on the optical path in the optical detecting apparatus. In the detecting device according to the present technology, light transmitting portions may be arranged on both sides of the sample holding unit so as to interpose the same therebetween. Also, cleaning units may be arranged on both sides of the main body so as to interpose the same therebetween. Furthermore, the detecting device according to the present technology may be provided with a light reflecting portion on a side opposite to the sample holding unit which the light transmitting portion faces.

The present technology next provides an optical detecting apparatus using a detecting device provided with a sample holding unit which holds a sample, and a light transmitting portion facing at least a part of the sample holding unit and located on an optical path in the optical detecting apparatus at the time of installation on the optical detecting apparatus, the optical detecting apparatus including

a first cleaning unit arranged at a position opposed to the light transmitting portion. The optical detecting apparatus according to the present technology may also be provided with a blower unit which blows air to the light transmitting portion. Also, the optical detecting apparatus according to the present technology may further be provided with a second cleaning unit which passes through a position opposed to a member on the optical path in the optical detecting apparatus by movement.

The present technology further provides an optical detecting method using a detecting device provided with a sample holding unit which holds a sample, and a light transmitting portion facing at least a part of the sample holding unit and located on an optical path in an optical detecting apparatus at the time of installation on the optical detecting apparatus, the optical detecting method including

performing a cleaning step of cleaning a member on an optical path in the detecting device and/or a member on the optical path in the optical detecting apparatus. At the cleaning step in the optical detecting method according to the present technology, the member on the optical path in the optical detecting apparatus may be cleaned by a cleaning unit provided in the detecting device. Also, at the cleaning step, the light transmitting portion of the detecting device may be cleaned by a cleaning unit provided in the optical detecting apparatus.

### Effects of the Invention

According to the present technology, it is possible to efficiently remove dust, dirt and the like adhering to the optical system member in the optical detection, and as a result, it is possible to contribute to improvement in detection accuracy.

Meanwhile, the effects are not necessarily limited to the effects herein described and may be any of the effects described in the present technology.

### BRIEF DESCRIPTION OF DRAWINGS

FIG. 1 is a schematic diagram schematically illustrating a first embodiment of a detecting device 1 according to the present technology.

FIGS. 2A to 2C are schematic diagrams illustrating a state in which the first embodiment of the detecting device 1 according to the present technology is installed on an optical detecting apparatus 10.

FIGS. 3A to 3C are schematic diagrams illustrating a state in which a second embodiment of the detecting device 1 according to the present technology is installed on the optical detecting apparatus 10.

FIGS. 4A to 4C are schematic diagrams illustrating a state in which a third embodiment of the detecting device 1 according to the present technology is installed on the optical detecting apparatus 10.

FIGS. 5A to 5D are schematic diagrams illustrating a state in which a fourth embodiment of the detecting device 1 according to the present technology is installed in the optical detecting apparatus 10.

FIGS. 6A to 6D are schematic diagrams illustrating a state in which a fifth embodiment of the detecting device 1 according to the present technology is installed on the optical detecting apparatus 10.

FIG. 7 is a schematic conceptual diagram schematically illustrating a first embodiment of the optical detecting apparatus 10 according to the present technology.

FIGS. 8A to 8C are schematic diagrams illustrating a state in which the detecting device 1 is installed on the first embodiment of the optical detecting apparatus 10 according to the present technology.

FIGS. 9A to 9C are schematic diagrams illustrating a state in which the detecting device 1 is installed on a second embodiment of the optical detecting apparatus 10 according to the present technology.

FIGS. 10A to 10C are schematic diagrams illustrating a state in which the detecting device 1 is installed on a third embodiment of the optical detecting apparatus 10 according to the present technology.

FIGS. 11A to 11D are schematic diagrams illustrating a state in which the detecting device 1 is installed on a fourth embodiment of the optical detecting apparatus 10 according to the present technology.

FIGS. 12A to 12D are schematic diagrams illustrating a state in which the detecting device 1 is installed on a fifth embodiment of the optical detecting apparatus 10 according to the present technology.

FIGS. 13A to 13C are schematic diagrams illustrating a state in which the detecting device 1 is installed on a sixth embodiment of the optical detecting apparatus 10 according to the present technology.

FIG. 14 is a schematic diagram schematically illustrating a first embodiment of a detecting kit K.

### MODE FOR CARRYING OUT THE INVENTION

Hereinafter, a preferred mode for carrying out the present technology is described with reference to the drawings. An embodiment hereinafter described illustrates an example of a representative embodiment of the present technology, and the scope of the present technology is not narrowed by the same. Meanwhile, the description is given in the following order.

1. Detecting Device 1
(1) Overall Structure
(2) Sample Holding Unit 11
(3) Light Transmitting Portion 12
(4) Cleaning Unit 13
(5) Light Reflecting Portion 14

2. Optical Detecting Apparatus 10
(1) Device Installation Portion 101
(2) First Cleaning Unit 102
(3) Blower Unit
(4) Second Cleaning Unit 104
(5) Light Irradiation Unit 105
(6) Optical Control Mechanism 106
(7) Optical Detection Unit 107
(8) Analysis Unit
(9) Display Unit
(10) User Interface

3. Detecting Kit K
(1) Sample Introducing Member K1

4. Optical Detecting Method
(1) Cleaning Step (I)
(2) Light Irradiating Step (II)
(3) Optical Detecting Step (III)
(4) Analyzing Step (IV)

<1. Detecting Device 1>

(1) Overall Structure

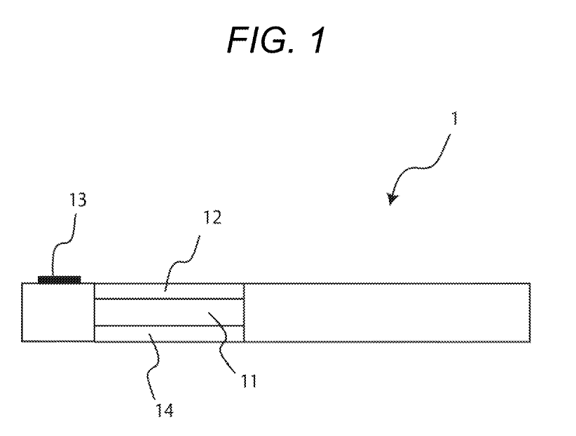

FIG. 1 is a schematic diagram schematically illustrating a first embodiment of a detecting device 1 according to the present technology. The detecting device 1 according to the present technology is roughly provided with a main body provided with a sample holding unit 11 and a light transmitting portion 12, and a cleaning unit 13. It is also possible to be further provided with a light reflecting portion 14 and the like as required.

As long as the detecting device 1 according to the present technology is provided with the above-described units, a method of forming the same is not especially limited, but it is also possible to form the same by bonding a plurality of substrates, for example. Materials forming the substrates are not especially limited, and a material which may be used for a light detecting device and the like such as a bioassay device may be freely selected and used in general. For example, it is possible to use a substrate of light-transmissive plastic resin such as polycarbonate, polyolefin series, and acrylic series, silicon resin such as polydimethylsiloxane (PDMS), glass and the like.

Hereinafter, each part of the detecting device 1 according to the present technology is described in detail.

(2) Sample Holding Unit 11

The sample holding unit 11 is a part which accommodates a sample being a subject.

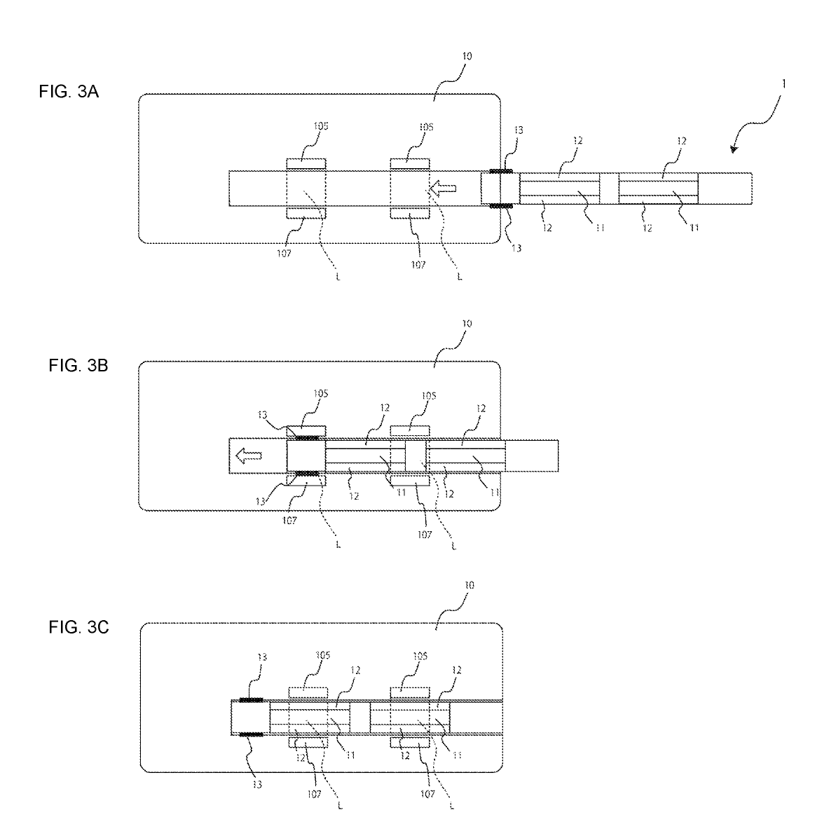

In the detecting device 1 according to the present technology, the number of the sample holding units 11 is not especially limited as long as this is at least one or larger, and this may be freely designed according to a type of the sample, a detecting apparatus to be used and the like. For example, as illustrated in a second embodiment of FIG. 3 to be described later, two or more sample holding units 11 may also be provided.

In the present technology, the sample is not especially limited, but examples thereof include a biological sample and the like, for example. Examples of the biological sample include body fluid (such as blood, serum, plasma, and urine) or diluted solution thereof, and/or a drug additive and the like, for example.

In the detecting device 1 according to the present technology, a width, a depth, a cross-sectional shape and the like of the sample holding unit 11 are not especially limited, and may be freely designed as long as an effect of the present technology is not deteriorated. For example, the cross-sectional shape may be freely designed to be a circle, a polygon (a triangle, a quadrangle, or a polygon having more angles), an ellipse, or a combination of one or two or more of them and the like.

Also, a shape in a depth direction is not especially limited, and may be freely designed to be a bowl shape, a cylindrical shape, a polygonal cylindrical shape having a polygonal (triangular, quadrangular, or with more angles) cross-section, a conical shape, a polygonal cone shape having a polygonal (triangular, quadrangular, or with more angles) cross-section, or a combination of one or two or more of them and the like, for example.

In the present technology, optical detection is performed in a state in which the sample is accommodated in the sample holding unit 11. The sample holding unit 11 may also be used as a stand-by place where the sample stands by for a certain period of time, or a reaction place where nucleic acid amplification, hybridization, and inter-substance interaction of nucleic acid, protein, cell and the like progress.

A specific method of introducing the sample into the sample holding unit 11 is not especially limited, and it is possible to introduce the same by a free method. For example, there is a method of directly spotting the sample on the sample holding unit 11, a method of spotting/injecting the sample on/to the sample holding unit 11 using an instrument such as a capillary (capillary tube) and a pipette.

(3) Light Transmitting Portion 12

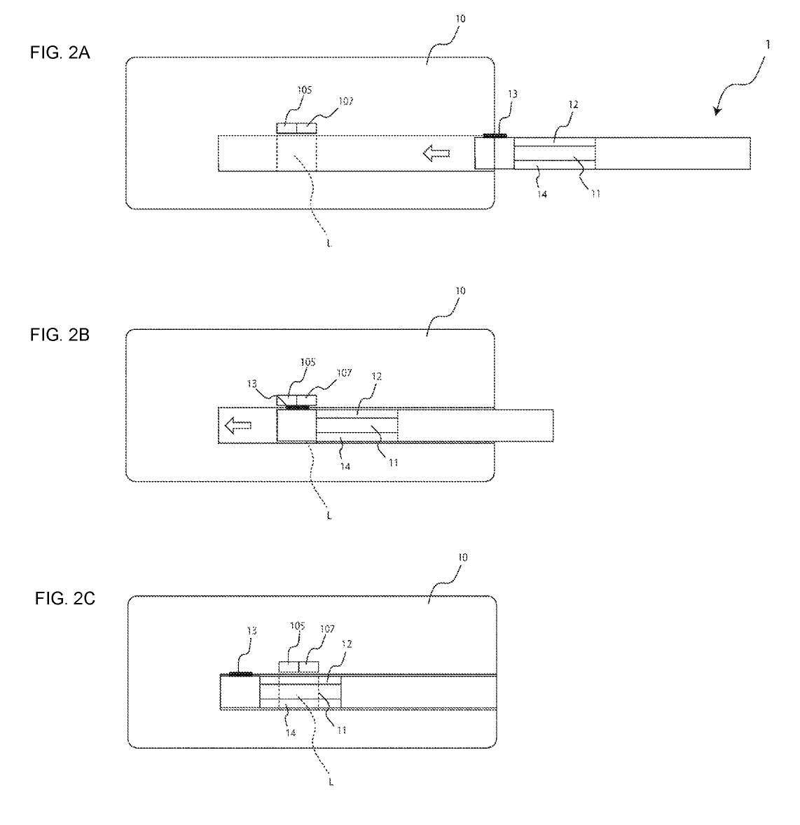

The light transmitting portion 12 faces at least a part of the sample holding unit 11. Also, when the detecting device 1 according to the present technology is installed on an optical detecting apparatus 10 to be described later, the light transmitting portion 12 is located on an optical path L in the optical detecting apparatus (refer to FIG. 2C).

In the present technology, the sample accommodated in the sample holding unit 11 is irradiated with light through the light transmitting portion 12, and the optical detection is performed from light emitted from the sample accommodated in the sample holding unit 11 through the light transmitting portion 12.

As long as the light transmitting portion 12 is provided so as to face at least a part of the sample holding unit 11 and so as to be located on the optical path L in the optical detecting apparatus 10 at the time of installation on the optical detecting apparatus 10, arrangement thereof other than this is not especially limited. Depending on a structure of the optical detecting apparatus 10 to be used, the arrangement of the light transmitting portion 12 may be freely designed. For example, as in the second embodiment illustrated in FIG. 3 to be described later, in a case where the light irradiation and the optical detection are performed from both sides of a chip in the optical detecting apparatus 10, it is also possible to arrange the light transmitting portions 12 on both sides of the sample holding unit 11 so as to interpose the same therebetween.

(4) Cleaning Unit 13

The cleaning unit 13 is arranged at a position opposed to a member on the optical path in the optical detecting apparatus 10, thereby cleaning an optical system member of the optical detecting apparatus 10. Hereinafter, a specific example of cleaning the optical system member of the optical detecting apparatus 10 using the cleaning unit 13 is described.

FIGS. 2A to 2C are schematic diagrams illustrating a state in which the first embodiment of the detecting device 1 according to the present technology is installed on the optical detecting apparatus 10. In the first embodiment, in a process of installing the detecting device 1 on the optical detecting apparatus 10, the cleaning unit 13 is brought into contact with the optical system member such as a light irradiation unit 105 and an optical detection unit 107, for example, of the optical detecting apparatus 10, thereby removing dust and dirt adhering to a surface of the optical system member.

That is, in the detecting device 1 according to the first embodiment, the cleaning unit 13 is arranged at the position opposed to the member on the optical path in the optical detecting apparatus 10 in the process of installing the detecting device 1 on the optical detecting apparatus 10.

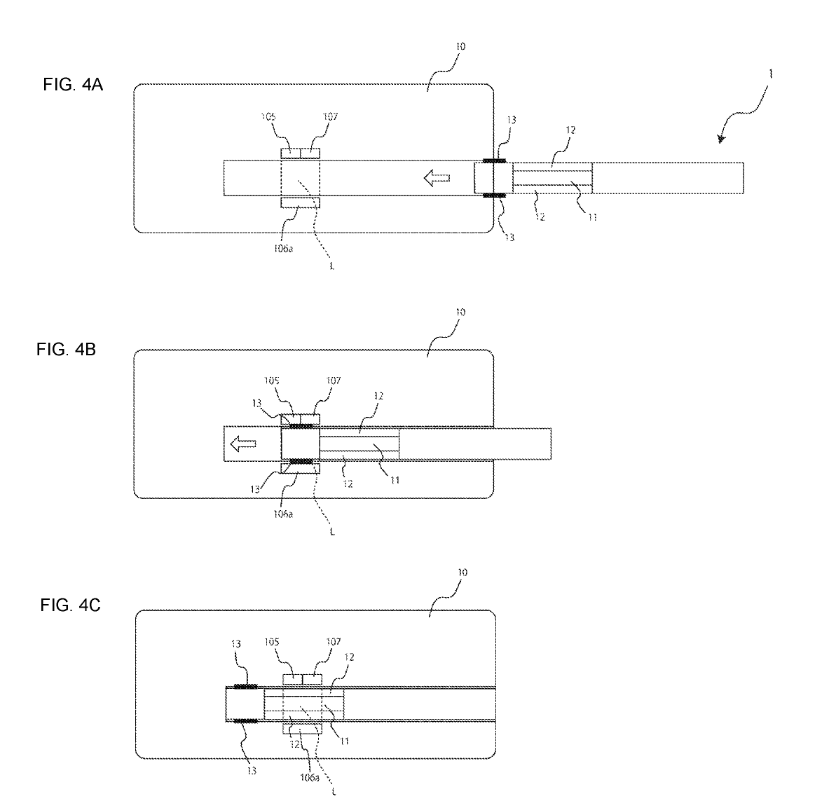

FIGS. 3A to 3C are schematic diagrams illustrating a state in which the second embodiment of the detecting device 1 according to the present technology is installed on the optical detecting apparatus 10, and FIGS. 4A to 4C are schematic diagrams illustrating a state in which a third embodiment of the detecting device 1 according to the present technology is installed on the optical detecting apparatus 10. The detecting devices 1 according to the second and third embodiments are examples in which the cleaning units 13 are arranged on both sides of the main body so as to interpose the same therebetween. For example, this is effective in a case where the light irradiation and the optical detection are performed from both sides of the detecting device 1 as illustrated in FIG. 3, in a case where the light emitted from the sample is reflected by a mirror 106a and the like and the light irradiation and the optical detection are performed from the same side as illustrated in FIG. 4 in the optical detecting apparatus 10.

For example, in the process of installing the detecting device 1 on the optical detecting apparatus 10, the cleaning unit 13 is brought into contact with the optical system member such the light irradiation unit 105, the optical detection unit 107, and the mirror 106a, for example, of the optical detecting apparatus 10, thereby removing dust and dirt adhering to the surface of the optical system member.

That is, in the detecting devices 1 according to the second and third embodiments also, the cleaning unit 13 is arranged at the position opposed to the member on the optical path in the optical detecting apparatus 10 in the process of installing the detecting device 1 on the optical detecting apparatus 10.

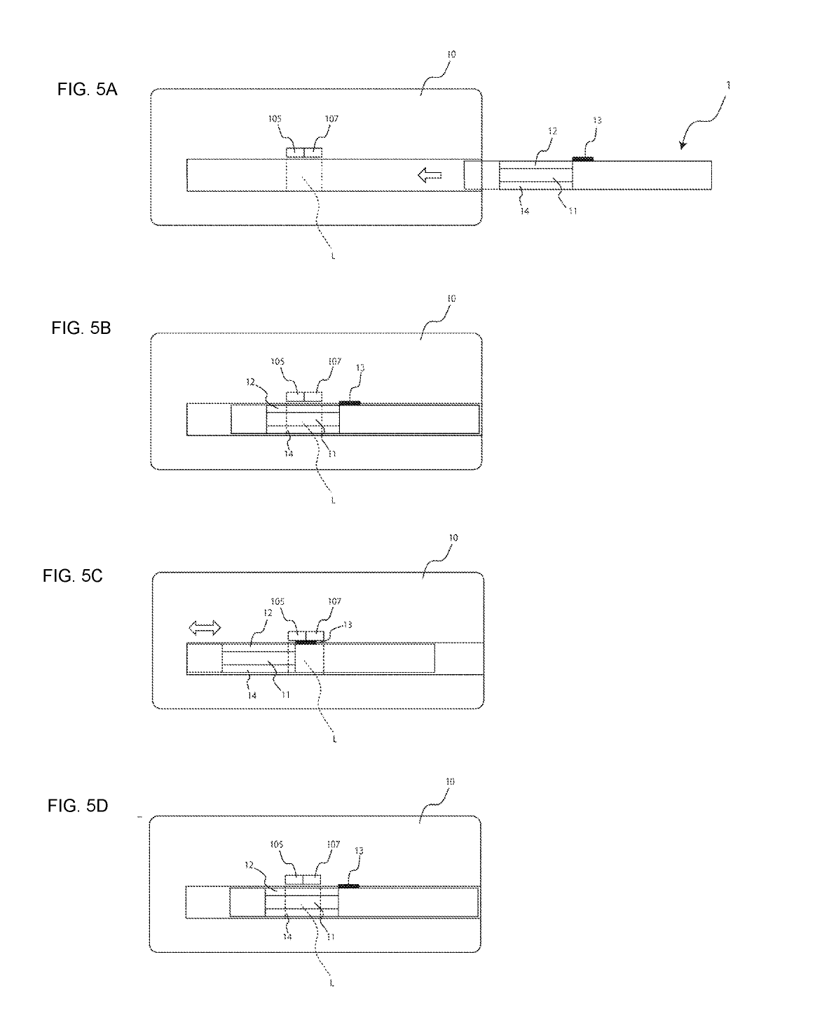

FIGS. 5A to 5D are schematic diagrams illustrating a state in which a fourth embodiment of the detecting device 1 according to the present technology is installed on the optical detecting apparatus 10. After the detecting device 1 according to the fourth embodiment is installed on the optical detecting apparatus 10, the detecting device 1 is scanned in the optical detecting apparatus 10 before actual detection is performed (refer to FIG. 5C), so that the cleaning unit 13 is brought into contact with the optical system member such as the light irradiation unit 105 and the optical detection unit 107, for example, of the optical detecting apparatus 10, thereby removing dust and dirt adhering to the surface of the optical system member. Thereafter, the detecting device 1 returns to its original position and detection is performed (refer to FIG. 5D).

That is, in the detecting device 1 according to the fourth embodiment, the cleaning unit 13 is arranged at the position opposed to the member on the optical path in the optical detecting apparatus 10 in the process of scanning the detecting device 1 after the detecting device 1 is installed on the optical detecting apparatus 10.

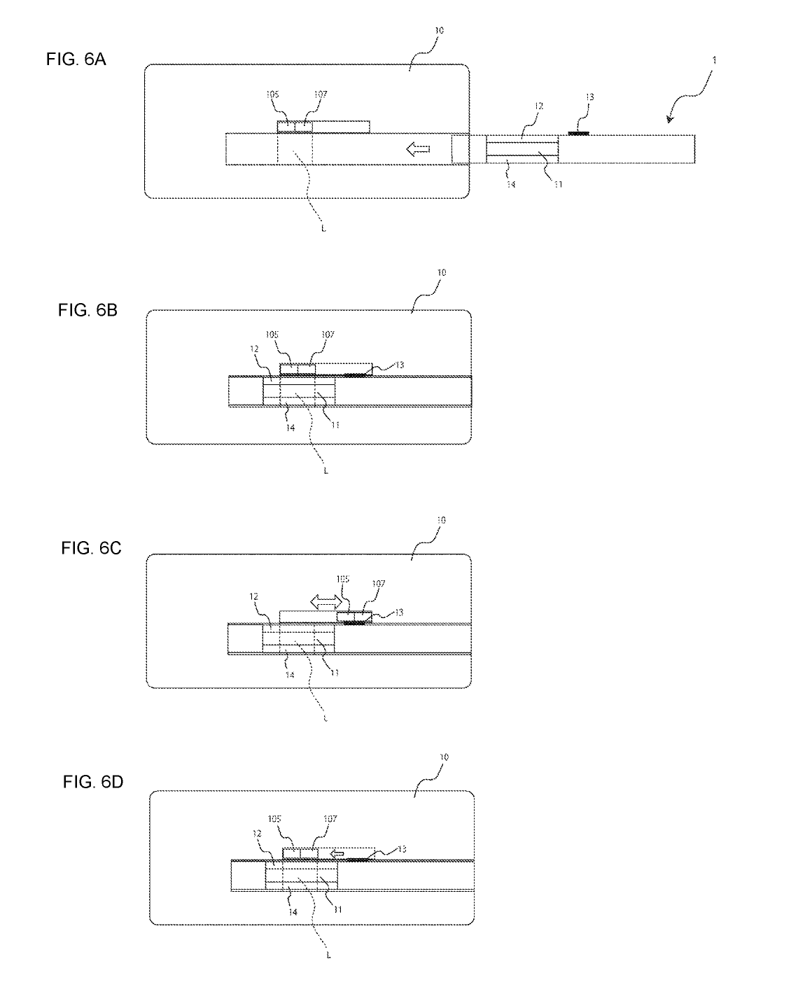

FIGS. 6A to 6D are schematic diagrams illustrating a state in which a fifth embodiment of the detecting device 1 according to the present technology is installed on the optical detecting apparatus 10. After the detecting device 1 according to the fifth embodiment is installed on the optical detecting apparatus 10, this is scanned by the optical system member such as the light irradiation unit 105 and the optical detection unit 107, for example, in the optical detecting apparatus 10 before the actual detection is performed (refer to FIG. 6C), so that the cleaning unit 13 is brought into contact with the optical system member such as the light irradiation unit 105 and the optical detection unit 107, for example, of the optical detecting apparatus 10, thereby removing dust and dirt adhering to the surface of the optical system member. Thereafter, the optical system member such as the light irradiation unit 105 and the optical detection unit 107 returns to its original position and the detection is performed (refer to FIG. 6D).

That is, in the detecting device 1 according to the fifth embodiment, the cleaning unit 13 is arranged at the position opposed to the member on the optical path in the optical detecting apparatus 10 in the process of scanning by the optical system member in the optical detecting apparatus 10 after the detecting device 1 is installed on the optical detecting apparatus 10.

(5) Light Reflecting Portion 14

The detecting device 1 according to the present technology may be provided with the light reflecting portion 14. Although the light reflecting portion 14 is not indispensable in the present technology, by providing the light reflecting portion 14 on a side opposite to the sample holding unit 11 which the light transmitting portion 12 faces as in the first embodiment illustrated in FIG. 1 described above, for example, it becomes possible to perform the light irradiation and the optical detection in the same direction.

<2. Optical Detecting Apparatus 10>

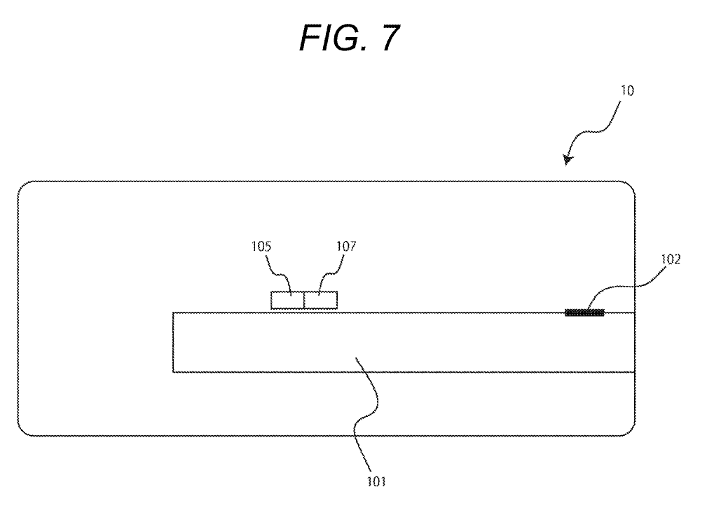

FIG. 7 is a schematic conceptual diagram schematically illustrating a first embodiment of the optical detecting apparatus 10 according to the present technology. The optical detecting apparatus 10 according to the present technology is roughly provided with a first cleaning unit 102. Also, a device installation portion 101, a blower unit 103, a second cleaning unit 104, the light irradiation unit 105, an optical control mechanism 106, the optical detection unit 107, an analysis unit, a display unit, a user interface and the like may further be provided as required.

Meanwhile, the detecting device 1 according to the present technology described above or a general commercially-available detecting device may be used as the optical detecting apparatus 10 according to the present technology.

Hereinafter, each part of the detecting device 1 according to the present technology is described in detail.

(1) Device Installation Portion 101

The device installation portion 101 is a part where the detecting device 1 is installed. In the present technology, the device installation portion 101 may be freely designed according to a mode and the like of the detecting device 1.

The device installation portion 101 may be further provided with a temperature adjusting mechanism. In the present technology, the temperature adjusting mechanism is a mechanism which keeps temperature of the sample held in the sample holding unit 11 constant. By including the temperature adjusting mechanism, the temperature of the sample becomes constant, and a measurement error and the like caused by temperature change of the sample may be decreased. A specific configuration of the temperature adjusting mechanism is not especially limited; for example, the device installation portion 101 is formed by including a material which may keep heat.

(2) First Cleaning Unit 102

The first cleaning unit 102 is arranged at a position opposed to the light transmitting portion 12 of the detecting device 1 to clean dust and dirt adhering to the surface of the light transmitting portion 12. Hereinafter, a specific example of cleaning the light transmitting portion 12 using the first cleaning unit 102 is described.

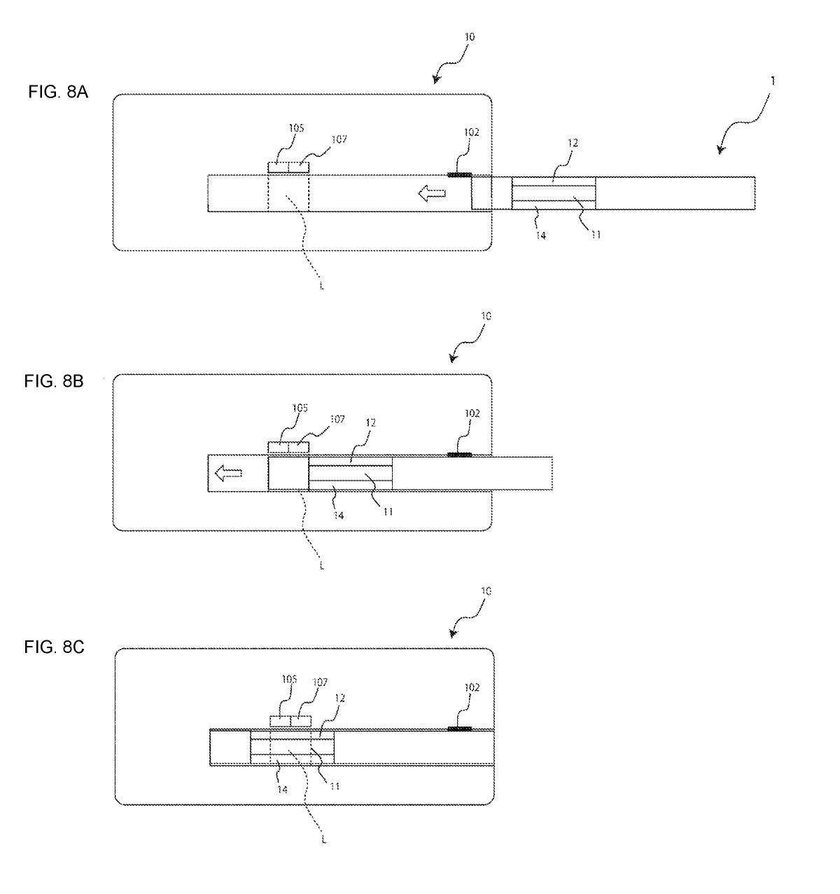

FIGS. 8A to 8C are schematic diagrams illustrating a state in which the detecting device 1 is installed on the first embodiment of the optical detecting apparatus 10 according to the present technology. In the first embodiment, in the process of installing the detecting device 1 on the optical detecting apparatus 10, the first cleaning unit 102 is brought into contact with the light transmitting portion 12 of the detecting device 1, thereby removing dust and dirt adhering to the surface of the light transmitting portion 12.

That is, in the optical detecting apparatus 10 according to the first embodiment, the first cleaning unit 102 is arranged at the position opposed to the light transmitting portion 12 of the detecting device 1 in the process of installing the detecting device 1 on the optical detecting apparatus 10.

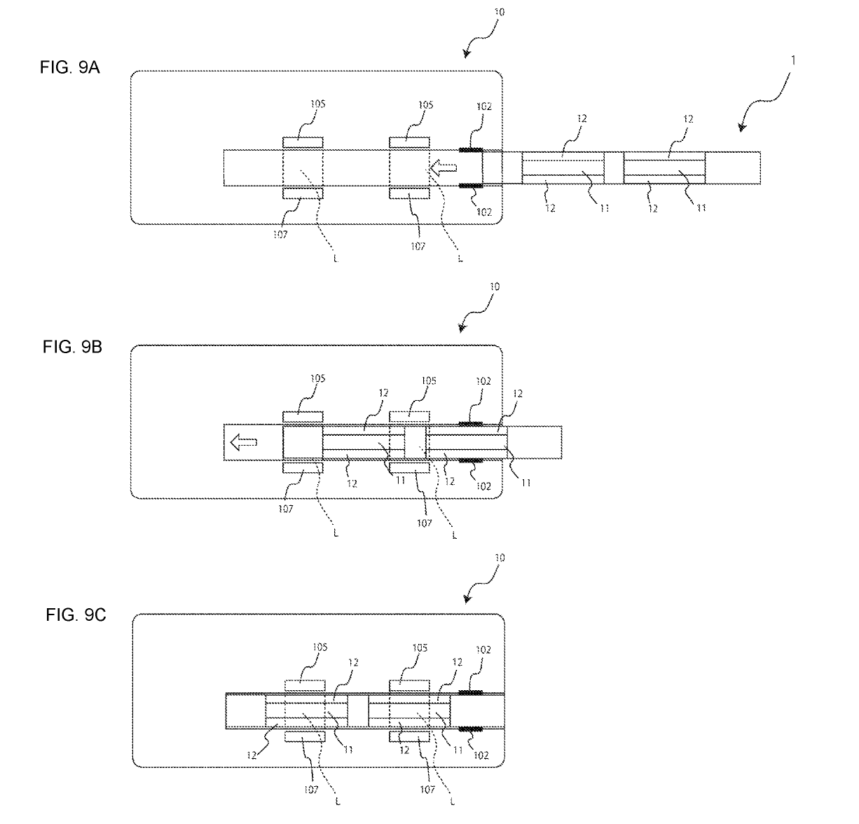

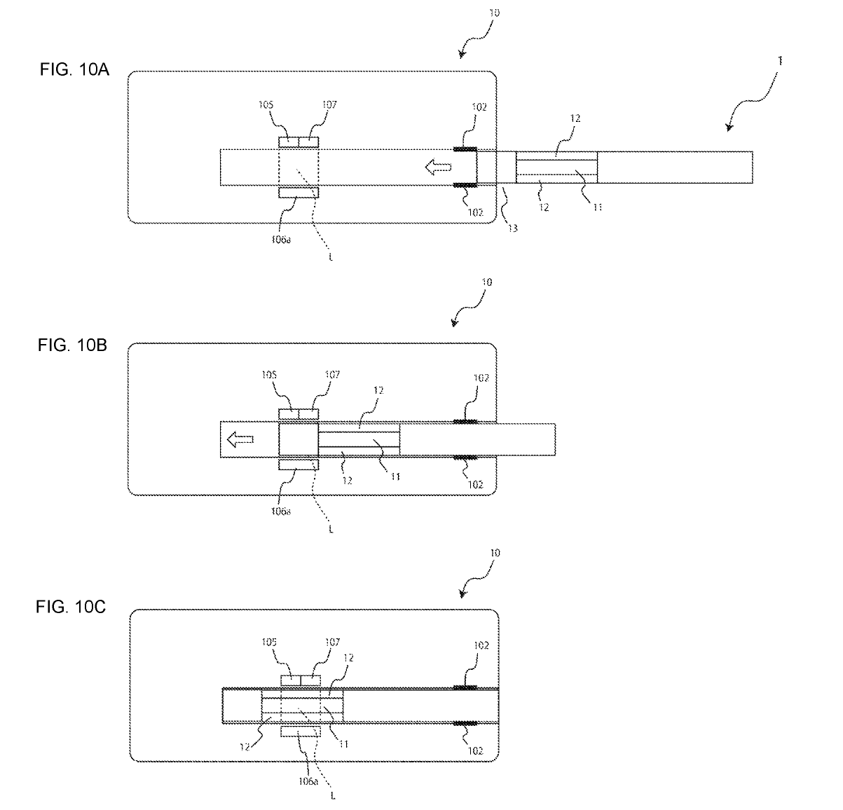

FIGS. 9A to 9C are schematic diagrams illustrating a state in which the detecting device 1 is installed on a second embodiment of the optical detecting apparatus 10 according to the present technology, and FIGS. 10A to 10C are schematic diagrams illustrating a state in which the detecting device 1 is installed on a third embodiment of the optical detecting apparatus 10 according to the present technology. The optical detecting apparatuses 10 according to the second and third embodiments are examples in which the first cleaning units 102 are arranged on both sides of the device installation portion 101. For example, this is effective in a case where the light irradiation and the optical detection are performed from both sides of the detecting device 1 as illustrated in FIG. 9, or in a case where the light emitted from the sample is reflected by the mirror 106a and the like and the light irradiation and the optical detection are performed from the same side as illustrated in FIG. 10 in the optical detecting apparatus 10.

For example, in the process of installing the detecting device 1 on the optical detecting apparatus 10, the first cleaning unit 102 is brought into contact with the light transmitting portion 12 of the detecting device 1, thereby removing dust and dirt adhering to the surface of the light transmitting portion 12.

That is, in the optical detecting apparatuses 10 according to the second and third embodiments, the first cleaning unit 102 is arranged at the position opposed to the light transmitting portion 12 of the detecting device 1 in the process of installing the detecting device 1 on the optical detecting apparatus 10.

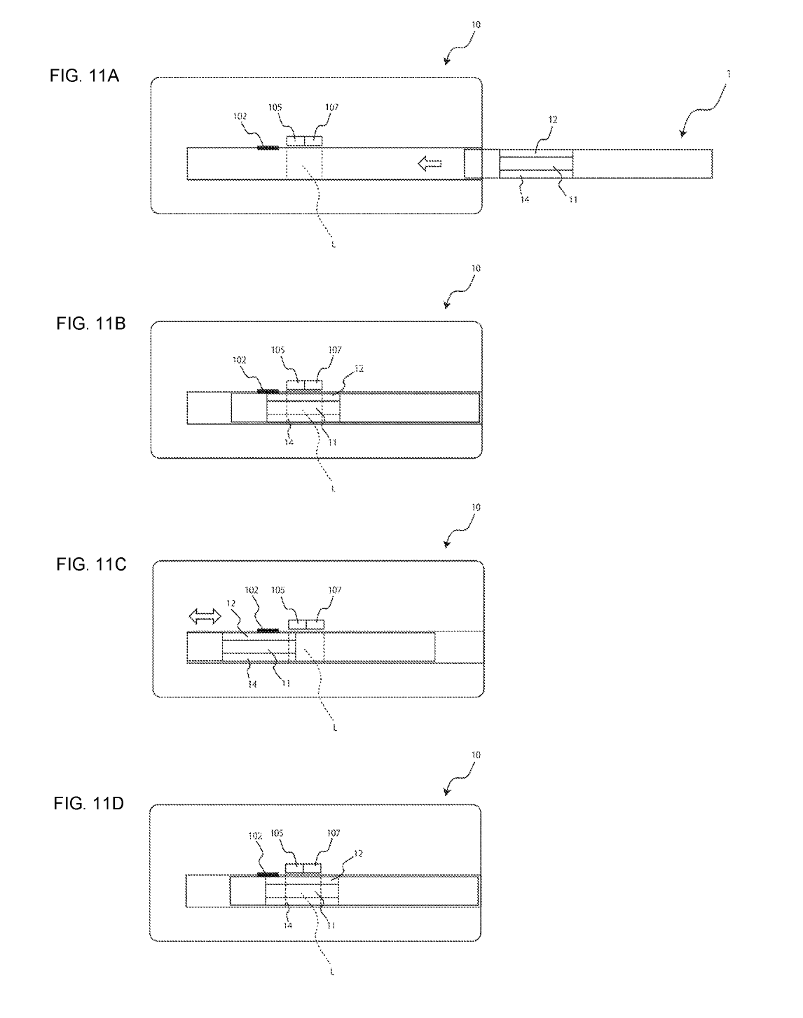

FIGS. 11A to 11D are schematic diagrams illustrating a state in which the detecting device 1 is installed on a fourth embodiment of the optical detecting apparatus 10 according to the present technology. The optical detecting apparatus 10 according to the fourth embodiment is such that, after the detecting device 1 is installed on the optical detecting apparatus 10, the detecting device 1 is scanned in the optical detecting apparatus 10 before the actual detection is performed (refer to FIG. 11C), so that the first cleaning unit 102 is brought into contact with the light transmitting portion 12 of the detecting device 1 to remove dust and dirt adhering to the surface of the light transmitting portion 12. Thereafter, the detecting device 1 returns to its original position and the detection is performed (refer to FIG. 10D).

That is, in the detecting devices 1 according to the fourth embodiment, the first cleaning unit 102 is arranged at the position opposed to the light transmitting portion 12 of the detecting device 1 in the process of scanning the detecting device 1 after installing the detecting device 1 on the optical detecting apparatus 10.

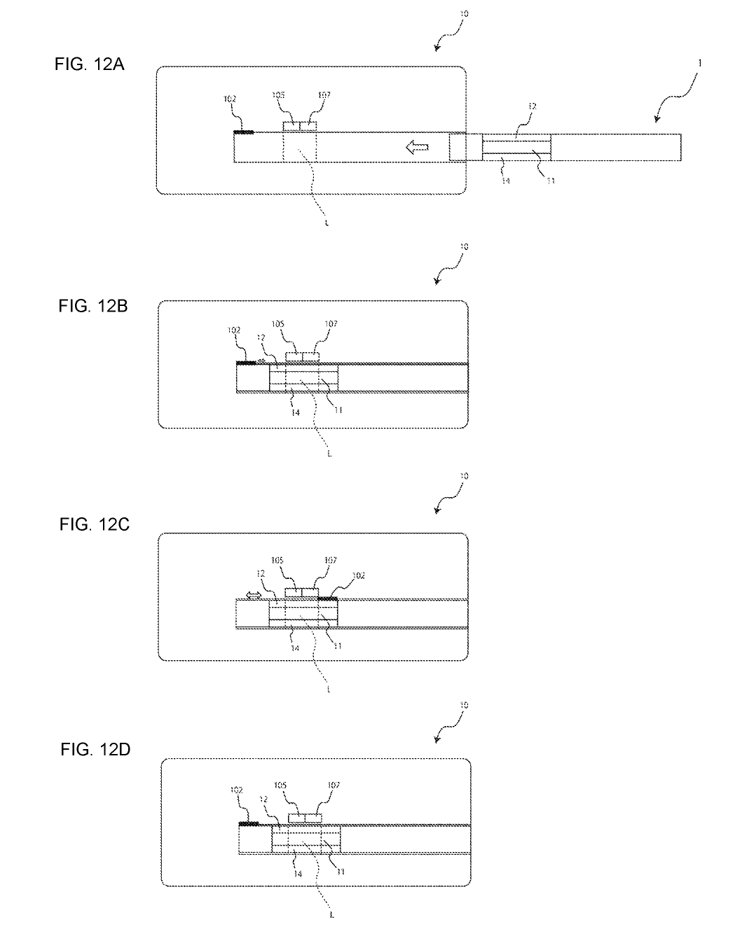

FIGS. 12A to 12D are schematic diagrams illustrating a state in which the detecting device 1 is installed on a fifth embodiment of the optical detecting apparatus 10 according to the present technology. The optical detecting apparatus 10 according to the fifth embodiment is such that, after the detecting device 1 is installed on the optical detecting apparatus 10, the first cleaning unit 102 scans in the optical detecting apparatus 10 before the actual detection is performed (refer to FIG. 12C), so that the first cleaning unit 102 is brought into contact with the light transmitting portion 12 of the detecting device 1 to remove dust and dirt adhering to the surface of the light transmitting portion 12. Thereafter, the first cleaning unit 102 returns to its original position and the detection is performed (refer to FIG. 10D).

That is, in the detecting devices 1 according to the fourth embodiment, the first cleaning unit 102 is arranged at the position opposed to the light transmitting portion 12 of the detecting device 1 in the process of scanning the first cleaning unit 102 after installing the detecting device 1 on the optical detecting apparatus 10.

(3) Blower Unit

The optical detecting apparatus 10 according to the present technology may also be provided with a blower unit which blows air to the light transmitting portion 12 of the detecting device 1. For example, a fan and the like for radiating heat may be used as the blower unit. Although this blower unit is not indispensable in the optical detecting apparatus 10 according to the present technology, by including the blower unit, it is possible to more certainly remove dust and dirt adhering to the light transmitting portion 12 of the detecting device 1 by blowing away dust and dirt that cannot be cleaned by the first cleaning unit 102, or by cleaning by the first cleaning unit 102 after blowing away large dust by the blower unit in advance.

Also, the blower unit may also be used for the purpose of blowing away dust and dirt adhering to the first cleaning unit 102 by cleaning. By using the same in this manner, it is also possible to prolong a life of the first cleaning unit 102.

(4) Second Cleaning Unit 104

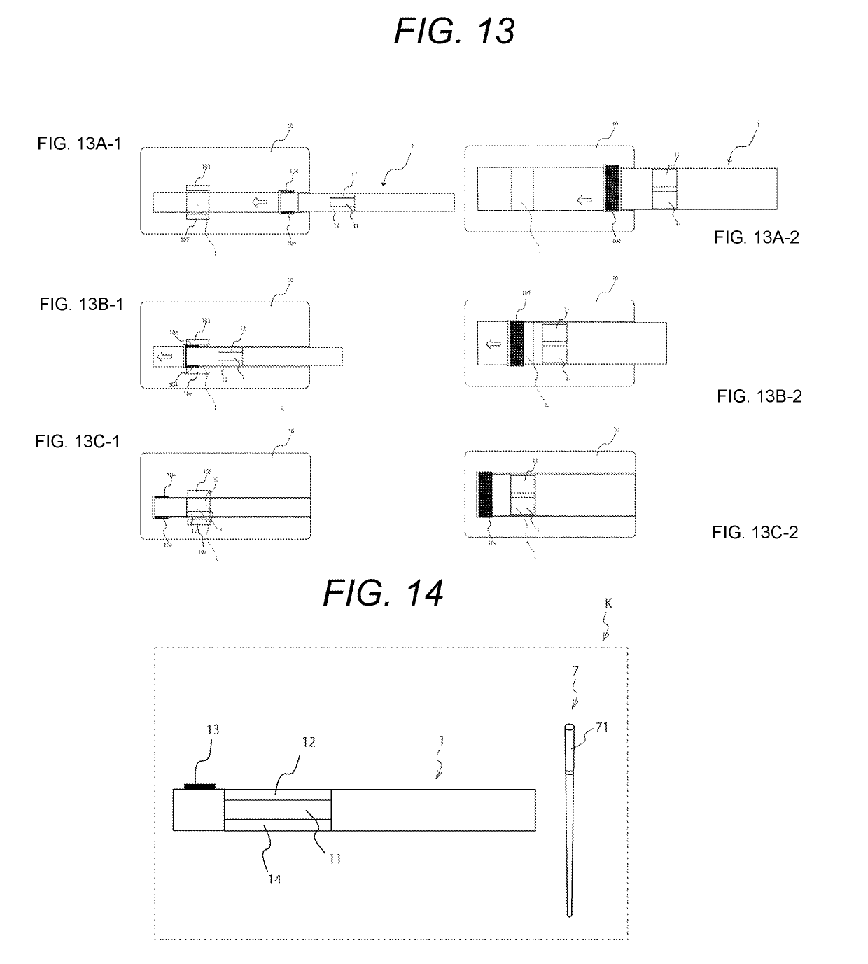

FIGS. 13A to 13C are schematic diagrams illustrating a state in which the detecting device 1 is installed on a sixth embodiment of the optical detecting apparatus 10 according to the present technology. The optical detecting apparatus 10 according to the sixth embodiment is provided with the second cleaning unit 104. The second cleaning unit 104 is used for removing dust and dirt adhering to the surface of the optical system member of the optical detecting apparatus 10 by movement. Hereinafter, a specific example of cleaning the optical system member of the optical detecting apparatus 10 using the second cleaning unit 104 is described.

FIGS. 13A-1, 13B-1, and 13C-1 are schematic diagrams illustrating a state in which the detecting device 1 is installed on the sixth embodiment of the optical detecting apparatus 10 according to the present technology from a side surface direction, and FIGS. 13A-2, 13B-2, and 13C-2 are schematic diagrams illustrating a state in which the detecting device 1 is installed on the sixth embodiment of the optical detecting apparatus 10 according to the present technology from an upper surface direction. In the sixth embodiment, in the process of installing the detecting device 1 on the optical detecting apparatus 10, the second cleaning unit 104 is pushed by the detecting device 1 to move and is brought into contact with the optical system member such as the light irradiation unit 105 and the optical detection unit 107, for example, of the optical detecting apparatus 10, thereby removing dust and dirt adhering to the surface of the optical system member.

That is, in the optical detecting apparatus 10 according to the sixth embodiment, the second cleaning unit 104 is arranged at the position opposed to the member on the optical path in the optical detecting apparatus 10 by the movement in the process of installing the detecting device 1 on the optical detecting apparatus 10.

(5) Light Irradiation Unit 105

The light irradiation unit 105 is a part which irradiates the sample held by the sample holding unit 11 of the detecting device 1 with light. A light irradiating method which may be used for the light irradiation unit 105 is not especially limited, and a known light irradiating method may be freely selected and used. For example, one or two or more light irradiating methods using a light emitting diode (LED), a semiconductor laser, EL illumination and the like may be freely selected and used.

Also, a specific method of arranging the light irradiation unit 105 is not especially limited as long as the irradiation of the sample with light is possible, and this may be arranged freely. For example, the light irradiation may be performed from above, below and the like of the detecting device 1.

Also, the light irradiation unit 105 may be freely set according to a function of the optical control mechanism 106 to be described later. For example, in a case where a dichroic mirror and the like is used as the optical control mechanism 106, it is also possible to perform the light irradiation from the side of the detecting device 1.

Furthermore, in a case where there are two or more sample holding units 11 in the detecting device 1, the light irradiation unit 105 may be provided for each sample holding unit 11, but in a case where a light dividing element, a light guide plate and the like is used as the optical control mechanism 106 to be described later, it is also possible to design such that one light irradiation unit 105 irradiates a plurality of sample holding units 11 with light.

(6) Optical Control Mechanism 106

The optical control mechanism 106 is a mechanism which controls the optical path of the light (for example, excitation light and the like) emitted from the light irradiation unit 105 described above and the light (for example, scattered light and the like) emitted from the sample.

As the optical control mechanism 106, one or two or more control mechanisms used in a known optical analyzing device may be freely combined to be used. For example, a lens such as a collimator lens and a condenser lens, a mirror such as a dichroic mirror, an optical filter, an aperture and the like, a light dividing element, a light guide plate, a partition wall and the like may be used as necessary.

(7) Optical Detection Unit 107

In the optical detection unit 107, the light (for example, scattered light and the like) emitted from the sample by the light irradiation is detected.

A light detecting method which may be used for the optical detection unit 107 is not especially limited, and any known light detecting method may be freely selected and used. For example, a method using an area image sensor such as a photo diode (PD), a charge coupled device (CCD), and a complementary metal oxide semiconductor (CMOS), a method using a so-called multichannel photodetector in which a plurality of photodetectors is arranged in an array pattern and the like may be adopted.

Also, a specific method of arranging the optical detection unit 107 is not especially limited as long as the light detection from the sample is possible, and it is possible to freely arrange. For example, the light detection may be performed from above, below and the like of the detecting device 1.

Also, the optical detection unit 107 may be freely designed according to the function of the optical control mechanism 106 described above. For example, in a case where the dichroic mirror and the like is used as the optical control mechanism 106, it is also possible to perform the light detection from the side of the detecting device 1.

Furthermore, in a case where there are two or more sample holding units 11 in the detecting device 1, the optical detection unit 107 may be provided for each sample holding unit 11, but it is also possible to design such that the light detection is performed from a plurality of sample holding units 11 by allowing one optical detection unit 107 to scan.

(8) Analysis Unit

The optical detecting apparatus 10 according to the present technology may further be provided with an analysis unit. On the basis of optical information of the sample detected by the optical detection unit 107, the analysis unit analyzes/determines a physical property of the sample, notifies of a determination result and the like. The analysis unit is not indispensable in the optical detecting apparatus 10 according to the present technology, and it is also possible to analyze using an external analyzing device and the like, for example.

(9) Display Unit

The optical detecting apparatus 10 according to the present technology may further be provided with a display unit. The display unit may display the optical information of the sample detected by the optical detection unit 107, an analysis result analyzed by the analysis unit and the like. The display unit is not indispensable in the optical detecting apparatus 10 according to the present technology, and it is also possible to analyze using an external display device and the like, for example.

(10) User Interface

The optical detecting apparatus 10 according to the present technology may further be provided with a user interface. The user interface is apart for a user (for example, an operator and the like) to operate. The user may access each part of the optical detecting apparatus 10 according to the present technology through the user interface.

As the user interface, for example, a mouse, a keyboard and the like may be used. The user interface is not indispensable in the optical detecting apparatus 10 according to the present technology, and it is also possible to operate by using an external operation device and the like, for example.

<3. Detecting Kit K>

FIG. 14 is a schematic diagram schematically illustrating a first embodiment of a detecting kit K according to the present technology.

Meanwhile, although the detecting device 1 of the first embodiment described above (refer to FIG. 1) is used in FIG. 14 as a matter of convenience, in the detecting kit K, a mode of the device 1 is not limited to this.

The detecting kit K according to the present technology is roughly provided with at least the above-described detecting device 1 and a sample introducing member K1. Meanwhile, since the detecting device 1 is similar to that described above, the description thereof is herein omitted.

(1) Sample Introducing Member 7

A sample introducing member 7 is a member for introducing the sample into the sample holding unit 11. Although a mode of the sample introducing member 7 is not especially limited, for example, examples thereof include a capillary (capillary tube) 71 and the like as illustrated in the first embodiment of FIG. 14.

Also, the sample introducing member 7 may be made disposable as the detecting device 1. By making the sample introducing member 7 disposable, it is possible to save time and labor of cleaning and the like of instruments used for sample introduction, so that convenience of the operator may be improved, and efficiency in detection, analysis and the like may be realized. Also, a risk of reusing the sample introducing member 7 may be decreased.

<4. Optical Detecting Method>

An optical detecting method according to the present technology is a method using the detecting device 1 according to the present technology and/or the optical detecting apparatus 10 according to the present technology described above, the method at least performing a cleaning step (I). A light irradiating step (II), an optical detecting step (III), an analyzing step (IV) and the like may also be performed as required.

(1) Cleaning Step (I)

The cleaning step (I) is a step of cleaning the member on the optical path in the detecting device 1 and/or the member on the optical path in the optical detecting apparatus 10. At the cleaning step (I), the member on the optical path in the optical detecting apparatus 10 may be cleaned by the cleaning unit 13 provided on the detecting device 1. At the cleaning step (I), it is also possible to clean the light transmitting portion 12 of the detecting device 1 by the cleaning unit (first cleaning unit 102) provided on the optical detecting apparatus 10. Furthermore, at the cleaning step (I), it is also possible to clean the member on the optical path in the optical detecting apparatus 10 by the cleaning unit (second cleaning unit 104) provided on the optical detecting apparatus 10.

Meanwhile, a specific cleaning method is the same as that of the cleaning unit 13 of the detecting device 1 according to the above-described technology and that of the first cleaning unit 102 and the second cleaning unit 104 of the optical detecting apparatus 10 according to the above-described present technology, so that the description thereof is herein omitted.

(2) Light Irradiating Step (II)

The light irradiating step (II) is a step of irradiating the sample held by the sample holding unit 11 of the detecting device 1 with light. A specific method of the light irradiation performed at the light irradiating step (II) is the same as the light irradiating method by the light irradiation unit 105 of the optical detecting apparatus 10 according to the present technology described above, so that the description thereof is herein omitted.

(3) Optical Detecting Step (III)

The optical detecting step (III) is a step of detecting the light (for example, scattered light and the like) emitted from the sample by the light irradiation. Since a specific method of the optical detection performed at the optical detecting step (III) is the same as the optical detecting method by the optical detection unit 107 of the optical detecting apparatus 10 according to the present technology described above, so that the description thereof is herein omitted.

(4) Analyzing Step (IV)

The analyzing step (IV) is a step of analyzing/determining the physical property of the sample, notifying the determination result and the like on the basis of the optical information of the sample detected at the optical detecting step (III). Since a specific analyzing method performed at the analyzing step (IV) is the same as the analyzing method by the analysis unit of the optical detecting apparatus 10 according to the present technology described above, the description thereof is herein omitted.

Meanwhile, the present technology may also have a following configuration.

(1)

A detecting device used for an optical detecting apparatus, including:

a main body provided with a sample holding unit which holds a sample, and a light transmitting portion facing at least a part of the sample holding unit and located on an optical path in the optical detecting apparatus at the time of installation on the optical detecting apparatus; and

a cleaning unit arranged at a position opposed to a member on the optical path in the optical detecting apparatus.

(2)

The detecting device according to (1),

in which light transmitting portions are arranged on both sides of the sample holding unit so as to interpose the sample holding unit therebetween.

(3)

The detecting device according to (1) or (2),

in which cleaning units are arranged on both sides of the main body so as to interpose the main body therebetween.

(4)

The detecting device according to any one of (1) to (3), further including:

a light reflecting portion on a side opposite to the sample holding unit which the light transmitting portion faces.

(5)

An optical detecting apparatus using a detecting device provided with a sample holding unit which holds a sample, and a light transmitting portion facing at least a part of the sample holding unit and located on an optical path in the optical detecting apparatus at the time of installation on the optical detecting apparatus,

the optical detecting apparatus including:

a first cleaning unit arranged at a position opposed to the light transmitting portion.

(6)

The optical detecting apparatus according to (5), further including:

a blower unit which blows air to the light transmitting portion.

(7)

The optical detecting apparatus according to (5) or (6), further including:

a second cleaning unit which passes through a position opposed to a member on the optical path in the optical detecting apparatus by movement.

(8)

An optical detecting method using a detecting device provided with a sample holding unit which holds a sample, and a light transmitting portion facing at least a part of the sample holding unit and located on an optical path in an optical detecting apparatus at the time of installation on the optical detecting apparatus,

the optical detecting method including:

performing a cleaning step of cleaning a member on an optical path in the detecting device and/or a member on the optical path in the optical detecting apparatus.

(9)

The optical detecting method according to (8), in which the member on the optical path in the optical detecting apparatus is cleaned by a cleaning unit provided in the detecting device at the cleaning step.

(10)

The optical detecting method according to (8) or (9),

in which the light transmitting portion of the detecting device is cleaned by a cleaning unit provided in the optical detecting apparatus at the cleaning step.

### REFERENCE SIGNS LIST

1 Detecting device
11 Sample holding unit
12 Light transmitting portion
13 Cleaning unit
14 Light reflecting portion
10 Optical detecting apparatus
101 Device installation portion
102 First cleaning unit
104 Second cleaning unit
105 Light irradiation portion
106 Optical control mechanism
107 Optical detection unit
K Detecting kit
7 Sample introducing member

1. A detecting device used for an optical detecting apparatus, comprising:
a main body provided with a sample holding unit which holds a sample, and a light transmitting portion facing at least a part of the sample holding unit and located on an optical path in the optical detecting apparatus at the time of installation on the optical detecting apparatus; and
a cleaning unit arranged at a position opposed to a member on the optical path in the optical detecting apparatus.

2. The detecting device according to claim 1,
wherein light transmitting portions are arranged on both sides of the sample holding unit so as to interpose the sample holding unit therebetween.

3. The detecting device according to claim 1,
wherein cleaning units are arranged on both sides of the main body so as to interpose the main body therebetween.

4. The detecting device according to claim 1, further comprising:
a light reflecting portion on a side opposite to the sample holding unit which the light transmitting portion faces.

5. An optical detecting apparatus using a detecting device provided with a sample holding unit which holds a sample, and a light transmitting portion facing at least a part of the sample holding unit and located on an optical path in the optical detecting apparatus at the time of installation on the optical detecting apparatus,
the optical detecting apparatus comprising:
a first cleaning unit arranged at a position opposed to the light transmitting portion.

6. The optical detecting apparatus according to claim 5, further comprising:
a blower unit which blows air to the light transmitting portion.

7. The optical detecting apparatus according to claim 5, further comprising:
a second cleaning unit which passes through a position opposed to a member on the optical path in the optical detecting apparatus by movement.

8. An optical detecting method using a detecting device provided with a sample holding unit which holds a sample, and a light transmitting portion facing at least a part of the sample holding unit and located on an optical path in an optical detecting apparatus at the time of installation on the optical detecting apparatus,
the optical detecting method comprising:
performing a cleaning step of cleaning a member on an optical path in the detecting device and/or a member on the optical path in the optical detecting apparatus.

9. The optical detecting method according to claim 8,
wherein the member on the optical path in the optical detecting apparatus is cleaned by a cleaning unit provided in the detecting device at the cleaning step.

10. The optical detecting method according to claim 8,
wherein the light transmitting portion of the detecting device is cleaned by a cleaning unit provided in the optical detecting apparatus at the cleaning step.
